(19) United States
(12) Patent Application Publication
(10) Pub. No.: US 2004/0112368 A1
(43) Pub. Date: Jun. 17, 2004

(54) Thermal food container

(76) Inventor: Deborah G. Amico, Wayland, NY (US)

Correspondence Address: Shlesinger, Fitzsimmons & Shlesinger, Suite 1323, 183 East Main Street, Rochester, NY, 14604, US

(21) Appl. No.: 10/320,955

(22) Filed: Dec. 17, 2002

(51) Int. Cl. A21B 1/04

(52) U.S. Cl. 126/273.5; 126/261; 126/400

(57) ABSTRACT

A thermal food container comprises a receptacle having an upwardly disposed opening and a bottom and side walls; and a lid coextensive with the opening. The bottom wall includes a first pocket with a first cover operable outside the receptacle, the first pocket being adapted to receive a first thermal storage device. The lid includes a second pocket with a second cover operable outside the receptacle when the lid is secured to the receptacle, the second pocket being adapted to receive a second thermal storage device.

### FIELD OF THE INVENTION

The present invention relates generally to a thermal food container and particularly to a food container, such as a salad bowl, sandwich tray or a food platter, with a portable device for cooling the food.

### OBJECTS AND SUMMARY OF THE INVENTION

It is an object of the present invention to provide a thermal food container with a portable thermal source, such as an ice pack, that can be accessed from outside the container, thereby avoiding the opening of the container and allowing ambient air in when it is needed to replace the thermal source.

It is still another object of the present invention to provide a thermal food container with a portable thermal source, such as an ice pack, disposed outside the container such that risk of contamination from condensate or ice melt with the food is minimized.

It is another object of the present invention to provide a thermal food container in the form of a salad bowl, sandwich tray, deviled egg tray or a vegetable/fruit platter made from inexpensive and highly insulating styrofoam and including a thermal source, such as an ice pack, easily accessible from the outside the container.

In summary, the present invention provides a thermal food container, comprising a receptacle having an upwardly disposed opening and a bottom and side walls; and a lid coextensive with the opening. The bottom wall includes a first pocket with a first cover operable outside the receptacle, the first pocket being adapted to receive a first thermal storage device. The lid includes a second pocket with a second cover operable outside the receptacle when the lid is secured to the receptacle, the second pocket being adapted to receive a second thermal storage device.

These and other objects of the present invention will become apparent from the following detailed description.

### BRIEF DESCRIPTIONS OF THE DRAWINGS

FIG. 1 is a cross-sectional view of a thermal food container made in accordance with present invention.

FIG. 2 is a top view of FIG. 1.

FIG. 3 is a cross-sectional view of another embodiment of a thermal food container made in accordance with the present invention.

### DETAILED DESCRIPTION OF THE INVENTION

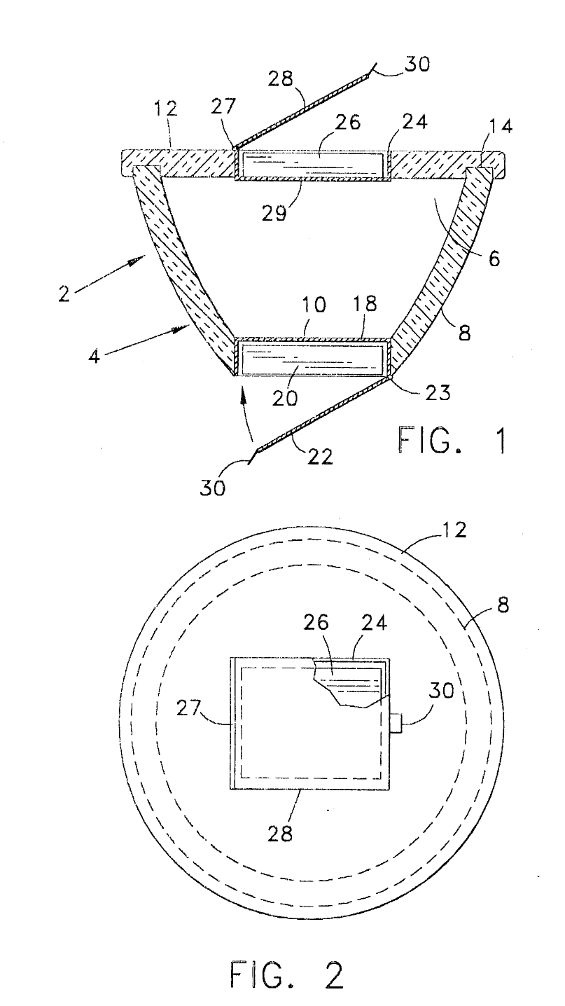

A thermal food container 2 made in accordance with the present invention is disclosed in FIG. 1. The container 2 comprises a receptacle 4 with an upwardly disposed opening 6, a side wall 8 and a bottom wall 10. A lid 12 provides a closure to the opening 6 and is co-extensive with the opening. A peripheral groove 14 receives the outer edge 16 of the receptacle to provide a positive closure.

A pocket 18 is preferably provided in the bottom wall 10 for receiving a thermal storage device 20, such as an ice pack or gel pack. A cover 22 is preferably connected to the receptacle 4 with hinge 23 for closing the opening to the pocket 18. The hinge 23 is preferably made of plastic material. The cover 22 is advantageously operable from outside the receptacle to provide access to the pocket 18 and the thermal storage device 20 while keeping the lid 12 closed. In this manner, the container need not be emptied or the contents otherwise disturbed to gain access to the pocket if it were accessible from the inside. Further, the pocket is blocked off and does not communicate, such as by holes or slots, with the interior of the container to minimize any risk of contaminating the contents of the receptacle 4 from ice melt or condensate forming on the thermal storage device surface. The pocket 18 is preferably molded or built in into the receptacle 4.

A pocket 24 is disposed in the lid 12 for receiving another thermal storage device 26. A cover 28 is preferably connected to the lid 12 with hinge 27 to provide closure to the opening of the pocket. The hinge 27 is preferably made of the same plastic material as the cover 28. The cover 28 is advantageously operable from outside the receptacle when the lid 12 is secured to the receptacle 4 to provide access to the pocket 24 without opening the lid 12. Advantageously, the lid need not be removed from the receptacle 4 to gain access to the pocket 24, which would be the case if it were located on the bottom surface of the lid. In this manner, the cold air within the container will remain inside. The pocket 24 is configured such that an air space between the bottom surface of the cover 28 and the top surface of the thermal storage device 26 is provided for insulation. The pocket 24 is preferably molded or built-in into the lid 12. The pocket 24 is advantageously blocked off from the interior of the container to minimize any risk of contaminating the contents of the receptacle 4 from the any condensate or ice melt formed from the thermal storage device 26.

The pockets 18 and 24 may be made separately and then integrated or built-in into the receptacle 4 and the lid 12, respectively. The pockets may also be molded with the respective receptacle and lid.

Although the container 4 is disclosed as a salad bowl, with the receptacle being a truncated sphere and the lid 12 being circular, other shapes may be made, depending on the application. The receptacle 4 and lid 12 are preferably made of styrofoam, which is a relatively inexpensive material and possesses good insulating characteristics.

The bottom wall 10 of the pocket 18 is preferably made of a rigid plastic material that allows heat transfer between the contents and the heat storage device 20. The bottom 29 of the pocket 24 is also made of a thin rigid plastic material that allows heat transfer between the thermal storage device 26 and the interior fo the container.

The receptacle 4 and the lid 12 may also be made in different shapes, such rectangular. When the pockets 18 and 24 are molded into the respective receptacle 4 and lid 12, any suitable material may be used that provides heat transfer between the thermal storage devices 20 and 26 the contents of the receptacle 4, while at the same maintaining a suitable insulation from the ambient temperature. The lid 12 may be secured to the receptacle 4 in a sealing, airtight manner, as commonly found in standard airtight food containers, such as those available from Tupperware.

A finger clasp 30 is provided for the covers 22 and 28 for convenient opening and closing of the respective covers.

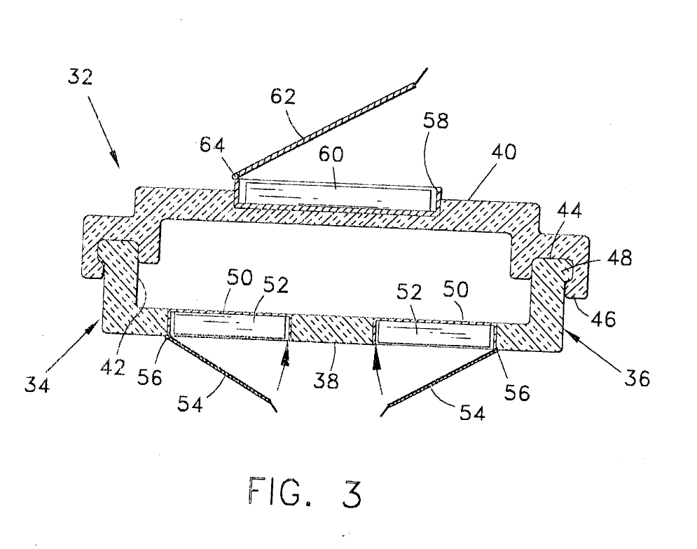

Another embodiment of a thermal food container 32 is disclosed in FIG. 3. The container 32 may be a sandwich tray, a deviled egg tray or a vegetable/fruit platter, which can be of any shape, such as rectangular. The thermal food container 32 includes a receptacle 34 with a side wall 36 and a bottom wall 38. A lid 40 provides closure to the opening 42 of the receptacle 34. The lid 40 is preferably provided with a peripheral groove 44 with inwardly projecting lip 46 that cooperates with an outwardly projecting lip 48 along the outer edge of the opening 42 of the receptacle 34.

The bottom wall of the receptacle 34 is provided with a plurality of pockets 50 for receiving a respective thermal storage device 52, such as an ice pack. A cover 54 is provided for each pocket 50. The covers 54 are advantageously operable from outside the receptacle 34 to provide access to the respective pockets without emptying the contents of the receptacle which would be the case if the covers were operable from within. The covers 54 are preferably provided with hinges 56 secured to the receptacle 34.

The lid 40 is also provided with a pocket 58 for receiving a thermal storage device 60, such as an ice pack or a cooling gel pack. A cover 62 provides closure to the opening of the pocket. The cover 62 is preferably connected to the lid 40 with a hinge 64. Depending on the size of the receptacle 34, multiple pockets may be provided in the lid 40, although only one is shown. The cover 62 is advantageously operable from outside the receptacle 34 when the lid 40 is secured to the receptacle. In this manner, access to the pocket 60 is provided, for example, for replacing the thermal storage device 52, without lifting the lid 40 off the receptacle 34, thereby maintaining the temperature within the receptacle.

The receptacle 34 and the lid 40 may be made of any suitable material, such as styrofoam, which is relatively inexpensive and has good insulating properties. The pockets 50 and 58 may be made with rigid plastic material that permits heat transfer between the thermal storage devices 52 and 60 and the contents of the receptacle 34. In addition, the peripheral portion of the cover 40 may be made with a flexible material, such as plastic, to provide the lip 46 to flex and grasp the lip 48 of the receptacle. The engagement of the cover 40 with the receptacle 34 may be in a sealing, airtight manner, as commonly found in standard airtight food containers, such as those available from Tupperware.

The pockets disclosed in the embodiments above are preferably molded or built-in with the respective container components.

While this invention has been described as having preferred design, it is understood that it is capable of further modification, uses and/or adaptations following in general the principle of the invention and including such departures from the present disclosure as come within known or customary practice in the art to which the invention pertains, and as may be applied to the essential features set forth, and fall within the scope of the invention or the limits of the appended claims.

I claim:

1. A thermal food container, comprising:
a) a receptacle having an upwardly disposed opening and a bottom and side walls;
b) a lid coextensive with said opening and in sealing engagement therewith,
c) said bottom wall including a first pocket with a first cover operable outside said receptacle, said first pocket being adapted to receive a first thermal storage device; and
d) said lid including a second pocket with a second cover operable outside said receptacle when said lid is secured to said receptacle, said second pocket being adapted to receive a second thermal storage device.

2. A thermal food container as in claim 1, wherein said side wall is made of styrofoam.

3. A thermal food container as in claim 1, wherein said lid is made of styrofoam.

4. A thermal food container as in claim 1, wherein said first cover is hingedly connected to said receptacle.

5. A thermal food container as in claim 1, wherein said second cover is hingedly connected to said lid.

6. A thermal food container as in claim 1, and further comprising said first thermal storage device.

7. A thermal food container as in claim 6, wherein said first thermal storage device is an ice pack.

8. A thermal food container as in claim 6, wherein said first thermal storage device is a gel pack.

9. A thermal storage device as in claim 1, and further comprising said second thermal storage device.

10. A thermal storage device as in claim 10, wherein said second thermal storage device is an ice pack.

11. A thermal storage device as in claim 10, wherein said second thermal storage device is a gel pack.

12. A thermal food container as in claim 1, wherein:
a) said lid includes a top surface; and
b) said second cover is flush with said top surface.

13. A thermal food container as in claim 1, wherein:
a) said bottom wall has an outside surface; and
b) said first cover is flush with said bottom wall outside surface.

14. A thermal food container as in claim 1, wherein said receptacle is round in plan view.

15. A thermal food container as in claim 1, wherein said receptacle is rectangular in plan view.

16. A thermal food container as in claim 1, wherein said receptacle is a truncated sphere.

17. A thermal food container as in claim 1, wherein said second cover protrudes above said lid.

18. A thermal food container as in claim 1, and further comprising a third pocket disposed on said bottom wall and including a third cover opening outside said receptacle, said third pocket being adapted to receive a third thermal storage device.

19. A thermal food container, comprising:
a) a receptacle having an upwardly disposed opening and bottom and side walls;
b) a lid coextensive with said opening, said lid being in sealing engagement with said receptacle; and
c) said lid including a pocket with a cover operable outside said receptacle when said lid is secured to said receptacle, said pocket being adapted to receive a thermal storage device.

20. A thermal food container as in claim 19, wherein said pocket is molded with said lid.

21. A thermal food container as in claim 19, wherein said pocket is configured to provide an airspace between said cover and a top surface of said thermal storage device.

22. A thermal food storage container as in claim 19, wherein said cover is flush with a top surface of said lid.

23. A thermal food storage container as in claim 19, wherein said cover protrudes above a top surface of said lid.

24. A thermal food storage container as in claim 19, wherein said cover is hingedly connected to said lid.

25. A thermal food container, comprising:
a) a receptacle having an upwardly disposed opening and bottom and side walls;
b) a lid coextensive with said opening and in sealing engagement therewith; and
c) said bottom wall including a built-in pocket with a cover secured to said receptacle, said cover being operable from outside said receptacle to gain access to said pocket, said pocket being adapted to receive a thermal storage device.

26. A thermal food container as in claim 25, wherein said cover is hingedly connected to said bottom wall.

27. A thermal food container, comprising:
a) a receptacle having an upwardly disposed opening and bottom and side walls;
b) a lid coextensive with said opening and in sealing engagement therewith; and
c) said receptacle including a built-in pocket with a cover secured to said receptacle, said cover being operable from outside said receptacle to gain access to said pocket, said pocket being adapted to receive a thermal storage device.

28. A thermal food container as in claim 27, wherein said pocket is disposed on a bottom portion of said receptacle.

29. A thermal food container as in claim 27, wherein said cover is hingedly connected to said receptacle.
